(19) United States
(12) Patent Application Publication
(10) Pub. No.: US 2016/0060390 A1
(43) Pub. Date: Mar. 3, 2016

(54) BRANCHED POLYESTER RESINS AND EASY TO CLEAN COATINGS COMPRISING THE SAME

(71) Applicant: PPG Industries Ohio, Inc., Cleveland, OH (US)

(72) Inventors: Edward R. Millero, JR., Glbsonia, PA (US); Irina G. Schwendeman, Wexford, PA (US); Debra L. Singer, Wexford, PA (US); Brian K. Rearick, Allison Park, PA (US); Shanti Swarup, Allison Park, PA (US)

(21) Appl. No.: 14/937,905

(22) Filed: Nov. 11, 2015

Related U.S. Application Data
(63) Continuation-in-part of application No. 12/752,570, filed on Apr. 1, 2010.

(51) Int. Cl. C08G 63/91; C09D 167/02

(52) U.S. Cl. CPC C08G 63/916; C09D 167/02

(57) ABSTRACT

An uncured, branched polyester resin prepared by free radical polymerization of unsaturated polyester prepolymers, wherein the polymerization occurs primarily by reaction of the unsaturation, is disclosed. Coatings comprising the same are also disclosed, as are substrates coated at least in part with such coatings.

### CROSS REFERENCE TO RELATED APPLICATIONS

This application is a continuation-in-part application of U.S. patent application Ser. No. 12/752,570, filed Apr. 1, 2010, entitled: “BRANCHED POLYESTER POLYMERS AND COATINGS COMPRISING THE SAME”.

### FIELD OF THE INVENTION

The present invention relates to uncured, branched polyester resins prepared by free radical polymerization of a double bond of at least one unsaturated polyester prepolymer in the presence of an ethylenically unsaturated compound comprising a siloxane group. The present invention further relates to coatings comprising such polyester resins and substrates to which such coatings are applied; the coating, when cured, may be easier to clean than coatings made with other polyesters.

### BACKGROUND OF THE INVENTION

Conventional linear and branched polyester resins produced by the polycondensation of different combinations of polyols and polyacids have been widely used in the coatings industry. They have been used to coat a wide range of metallic and non-metallic substrates used in a number of different industries. These industries particularly include those in which flexible coatings are desired. Particularly suitable examples include substrates used in the packaging industry, coil coatings, and certain industrial and automotive coatings. Stain resistance and easy clean-up are often desired characteristics of coatings, particularly those used in consumer products such as household appliances and consumer electronics. It is often desired that coatings have a particular “touch feel” as well; in the consumer electronics industry, for example, it is often desired to have a coating with a “soft feel” or “soft touch”. A soft touch coating can impart a range of touch feel, for example, a velvety feel, a silky feel, or a rubbery feel, to a substrate. It is also often desired that the coating have at least some degree of resistance to abrasion, marring, and/or scratching. Coatings having acceptable performance properties are therefore desired.

### SUMMARY OF THE INVENTION

The present invention is directed to an uncured, branched polyester resin prepared by free radical polymerization of a double bond of at least one unsaturated polyester prepolymer in the presence of an ethylenically unsaturated compound comprising a siloxane group, wherein the prepolymer comprises: a) a polyol segment; and b) an unsaturated polycarboxylic acid and/or an anhydride and/or ester segment.

The present invention is further directed to an uncured, branched polyester resin prepared by free radical polymerization of the double bonds of at least one unsaturated polyester prepolymer wherein the prepolymer comprises: a) a polyol segment; b) an unsaturated polycarboxylic acid and/or anhydride and/or ester segment; and c) a siloxane segment. The present invention is further directed to an uncured, branched polyester resin prepared by free radical polymerization of a double bond of a first unsaturated polyester prepolymer and a double bond of a second unsaturated polyester prepolymer, wherein each prepolymer independently comprises: a) a polyol segment; and b) an unsaturated polycarboxylic acid and/or an anhydride and/or ester segments; and wherein at least one of the unsaturated polyester prepolymers further comprises a siloxane segment; and wherein the prepolymers are the same or different.

Coating compositions comprising such polyester resins are also within the scope of the present invention, as are substrates coated at least in part with such coatings.

### DETAILED DESCRIPTION OF THE INVENTION

The present invention is directed to uncured, branched polyester resins generally comprising a reaction product of prepolymers and ethylenically unsaturated siloxane compounds, in which the prepolymers are the reaction product of components comprising a polyol segment and an unsaturated polycarboxylic acid and/or an anhydride and/or ester segment. The prepolymers are unsaturated polyesters, and are sometimes referred to herein as an “unsaturated polyester prepolymer”, “prepolymer” or like terms. Free radical initiators are used to initiate polymerization through the unsaturation of the unsaturated polyester prepolymers, thereby resulting in a branched polyester resin. The branched polyester resin is uncured and “crosslinkable”, which means that it can undergo crosslinking with another compound to form a cured coating, but is not itself a cured coating. That is, the polyester resin has functionality that will react with functionality on another compound, such as a crosslinker. Reaction of the unsaturation of the prepolymers results in the uncured, crosslinkable branched polyester resin. This polyester is a polymer resin. It is not a cured coating. The present invention is therefore distinct from art in which crosslinking the points of unsaturation on monomers and/or polymers results in curing of the coating.

The unsaturated polyester prepolymer comprises a polyol segment. “Polyol” and like terms, as used herein, refers to a compound having two or more hydroxyl groups, and the “polyol segment” refers to the portion of the prepolymer derived from the polyol. The polyol used to form the polyol segment is sometimes referred to herein as the “polyol segment monomer”. Polyols can be chosen to contribute softness to the prepolymer. Polyols can also contribute hardness, however, so the polyol(s) used and amount of each should be selected so that the unsaturated prepolymers, when reacted, result in a branched polyester having the desired Tg. A Tg of 25° C. or less may be desired to impart a “soft touch” to the final coating. Suitable polyols for use in the invention may be any polyol or mixtures thereof known for making polyesters. Examples include, but are not limited to, alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; cyclohexanedimethanol; hexanediols including 1,6-hexanediol; caprolactonediol (for example, the reaction product of epsilon-caprolactone and ethylene glycol); hydroxy-alkylated bisphenols; polyether glycols, for example, poly(oxytetramethylene)glycol; trimethylol propane, pentaerythritol, di-pentaerythritol, trimethylol ethane, trimethylol butane, dimethylol cyclohexane, glycerol and the like. Suitable unsaturated polyols for use in the invention may be any unsaturated alcohols containing two or more hydroxyl groups. Examples include, but are not limited to, trimethylol propane monoallyl ether, trimethylol ethane monoallyl ether and prop-1-ene-1,3-diol. The polyol segment can also comprise some mono-ol, such as up to 10 weight %, or 5 weight %, based on the total weight of the polyol segment. The polyol segment may comprise 10 to 90 weight % of the polyester prepolymer, such as 30 to 50 weight %. The percent of polyol in the prepolymer can vary widely depending on the molecular weight of the polyol segment.

The unsaturated polyester prepolymer further comprises an unsaturated polycarboxylic acid/anhydride/ester segment, which refers to that portion of the prepolymer derived from polycarboxylic acid/anhydride/ester. Suitable unsaturated polyacids for use in the invention may be any unsaturated carboxylic acid containing two or more carboxy groups and/or an ester and/or anhydride thereof, or mixtures thereof. Examples include, but are not limited to, maleic acid, fumaric acid, itaconic acid, citraconic acid, mesaconic acid and teraconic acid, and/or esters and/or anhydrides thereof. Where the unsaturated polyacid is in the form of an ester, these esters may be formed with any suitable alcohol, such as C1-C18 alkyl esters formed by reaction of a C1-C18 alcohol (e.g. methanol, ethanol, 1-propanol, 1-butanol, 2-butanol, isobutanol, 1-pentanol, 1-pentanol and 1-hexonol) with the polyacid. A particularly suitable unsaturated polyacid is maleic acid, maleic anhydride or a C1-C6 alkyl ester of maleic acid. The unsaturated polycarboxylic acid/anhydride/ester can comprise 3 to 25 weight % of the polyester prepolymer, such as 5 to 20 weight %.

The polyester prepolymer can further comprise one or more monomers that contribute to the overall properties of the polyester, including “softness”, stain resistance, durability, chemical resistance, and/or mechanical resistance. For example, one or more monomers that contribute a “soft segment” can be used with the one or more polyols and one or more unsaturated polycarboxylic acids/anhydrides/esters. As used herein, “soft segment” and like terms refers to a monomer or residue thereof or mixtures thereof that contribute flexibility to the prepolymer, and can help to obtain the desired Tg and/or viscosity of the branched polyester resin. The soft segment can be the residue of, for example, a polyacid. “Polyacid” and like terms, as used herein, refers to a compound having two or more acid groups and includes the ester and/or anhydride of the acid. Such acids can include, for example, linear acids that impart flexibility. Examples include but are not limited to saturated polyacids such as adipic acid, azelaic acid, sebacic acid, succinic acid, glutaric acid, decanoic diacid, dodecanoic diacid and esters and anhydrides thereof. Suitable monoacids include C1-C18 aliphatic carboxylic acids such as acetic acid, propanoic acid, butanoic acid, hexanoic acid, oleic acid, linoleic acid, undecanoic acid, lauric acid, isononanoic acid, other fatty acids, and hydrogenated fatty acids of naturally occurring oils; and/or esters and/or anhydrides of any of these.

One or more additional acids can also be used. For example, the additional acid can be an aromatic acid or a cycloaliphatic acid, suitable examples of which include, but are not limited to, phthalic acid, isophthalic acid, 5-tert-butylisophthalic acid, tetrachlorophthalic acid, benzoic acid, t-butylbenzoic acid, tetrahydrophthalic acid, naphthalene polycarboxylic acid, terephthalic acid, hexahydrophthalic acid, methylhexahydrophthalic acid, dimethyl terephthalate, cyclohexane dicarboxylic acid, chlorendic anhydride, 1,3-cyclohexane dicarboxylic acid, 1,4-cyclohexane dicarboxylic acid, tricyclodecane polycarboxylic acid, endomethylene tetrahydrophthalic acid, endoethylene hexahydrophthalic acid, cyclohexanetetra carboxylic acid, cyclobutane tetracarboxylic acid and esters and anhydrides thereof and/or combinations thereof. It will be appreciated that some of the additional acids listed above may impart rigidity to the branched polyester resin and therefore cause the Tg of the branched polyester resin to increase. One skilled in the art, therefore, will need to determine the acids used and amounts of each acid to impart the desired flexibility and feel, as well as other desired properties such as stain resistance, to the final coating.

Other monomer components can also be used in formation of the prepolymer to impart one or more additional properties to the branched polyester and/or coating comprising the same. For example, phthalic anhydride can be included, such as in amounts of 2 to 20 weight % of the prepolymer; phthalic anhydride might impart greater stain resistance to the coating. Fatty diacids could be added to increase hydrophobicity, while a polyether such as poly THF could be used to make the branched polyester resin more hydrophilic. Diene monomers, such as butadiene, may also contribute to soft feel, chemical resistance, and/or flexibility, and such as dicylcopentadiene, which may contribute to durability and a rubber-like feel.

The unsaturated polyester prepolymer can be prepared by any means known in the art. For example, a polyol segment may be reacted with the unsaturated polycarboxylic acid/anhydride/ester segment. If a soft segment is used, the polyol segment may be prereacted with the soft segment and then further reacted with the unsaturated polycarboxylic acid/anhydride/ester segment or the three segments can be reacted together. The polyol is typically in excess as compared to the soft segment when a soft segment is included. For example, the ratio of reactive groups on the soft segment monomer to reactive groups on the polyol segment monomer may be 1:2, 2:3 or even higher. The higher the ratio, the higher the molecular weight of the reaction product. Because an excess of polyol is used, the reaction product has terminal hydroxyl functionality. This functionality remains unreacted in the preparation of the uncured branched polyester resin, thereby rendering the polyester resin “crosslinkable” with another compound to form a cured coating. Similarly, when a soft segment is not used, the prepolymer has terminal hydroxyl or acid functionality that will be present in the uncured polyester resin and can be crosslinked with another compound to form a cured coating.

As noted above, it may be desired that the Tg of the crosslinkable, branched polyester resin is 25° C. or less. The Tg of the prepolymers reacted to form such a branched polyester resin may also be 25° C. or less. Alternatively, the Tg of one or more prepolymers may be greater than 25° C. while the Tg of one or more prepolymers may be 25° C. or less, such that, when reacted, the resulting branched polyester resin has a Tg of 25° C. or less. Tg values of greater than 25° C. may be desired depending on the needs of the user.

Following formation of the unsaturated polyester prepolymers, the prepolymers are then polymerized in the presence of a free radical initiator and an ethylenically unsaturated compound comprising a siloxane group or siloxane compound. A “siloxane group” will be understood as one having a Si—O—Si linkage. Particularly suitable ethylenically unsaturated siloxane compounds are acrylated siloxanes. The unsaturation on the polyester prepolymer is reacted with the unsaturation on the siloxane compound. It will be appreciated that the reaction occurs through free radical polymerization. The portion of the uncured resin derived from a siloxane compound is sometimes referred to herein as the “siloxane segment”.

It is also possible to form uncured, branched polyester resins according to the invention by free radical polymerization of the double bonds of at least one unsaturated polyester prepolymer wherein the prepolymer comprises:
a) a polyol segment;
b) an unsaturated polycarboxylic acid and/or anhydride and/or ester segment; and
c) a siloxane segment.

The siloxane segment, which in this context refers to the portion of the prepolymer derived from a siloxane compound, can be included in the polyester prepolymer by reacting a monomer comprising a siloxane group with the polyol segment, the unsaturated polycarboxylic acid/anhydride/ester segment, and/or the reaction product of these two segments. It will be appreciated that the siloxane segment in the prepolymer becomes the siloxane segment of the uncured resin. A particularly suitable method for incorporating a siloxane group into the polyester prepolymer is to react an acrylated siloxane with the reaction product of the polyol segment and the unsaturated polycarboxylic acid/anhydride/ester segment. Any other means known in the art could also be used to incorporate the siloxane group into the polyester prepolymer. While at least one of the prepolymers used according to the invention has a siloxane group, more than one or all of the prepolymers used can have such a group.

It is also possible to prepare the branched polyester resins of the present invention by free radical polymerization via the double bonds of a first and second unsaturated polyester prepolymer, wherein at least one of the prepolymers comprises a siloxane segment. The first and second prepolymers can be the same or different. For example, two or more different unsaturated polyester prepolymers can be reacted together. “Different”, in this context, means that one or more components used in the unsaturated polyester prepolymers and/or the amount of one or more components used in the unsaturated polyester prepolymers can be different. For example, polyester resin according to the present invention can be prepared using polyol prepolymers comprised of the same components; alternatively, they can be prepared by using two or more polyol prepolymers that are formed by different components. That is, a first polyol prepolymer comprising a terminal hydroxyl group and a second polyol prepolymer comprising a terminal hydroxyl group are reacted with an unsaturated acid/anhydride/ester; the components used to make the first and second prepolymers can be different, and/or can have one or more different components and/or can have one or more different amounts if the same components are used. The resulting polyester may be likely to have random units derived from each type of prepolymer used. Thus, the present invention encompasses polyesters prepared by prepolymers having the same or different polyol segment monomers, siloxane segment monomers, and/or unsaturated acids/anhydrides/esters segment monomers and/or the same or different amounts of any of these; moreover, each of the prepolymers can have the same or different soft segment monomers, if used, and/or additional acid monomers and/or the same or different amounts of any of these. Use of different polyol prepolymers, soft segment monomers, polyol segment monomers, additional monomers, unsaturated acids/anhydrides/esters, siloxane segment monomers and/or amounts of any of these may result in polyester resins having different properties. In this manner, polyester resins can be formed that have easy cleanability, that is, high stain resistance as measured as described in the examples, and possibly other desirable properties deriving from the use of the particular components used in the prepolymers.

It will be appreciated that use of a siloxane group in the free radical polymerization with an unsaturated polyester prepolymer or in at least one of the prepolymers that are reacted together by free radical polymerization will result in the siloxane group being present in the polyester resin, and therefore also in a coating formed from such a resin. The siloxane group can comprise 0.1 to 10 weight % of the polyester prepolymer, such as 0.5 to 5 weight %, where the weight % is based on the weight of the prepolymer. It will be appreciated that the siloxane group is hydrophobic, and may impart water resistance to a coating comprising the polyester. Stain resistance may also be observed as a result of the siloxane group.

When an ethylenically unsaturated prepolymer is reacted with an ethylenically unsaturated siloxane compound, unsaturation from the acid/anhydride/ester moiety in the prepolymer reacts with the unsaturation of the siloxane compound. When one or more prepolymers having a siloxane segment are reacted, the unsaturation of the prepolymers reacts. In any case, the result is an uncured, branched polyester resin. At least some if not all of the branches will have terminal hydroxyl groups. There may also be pendant functionality in the branched polyester resin as well, depending on the starting materials used. It was a very surprising and unexpected result to achieve a branched polyester resin according to the present invention. It will be appreciated that the branching in the present invention is predominantly achieved through reaction of the unsaturation. It is possible to also contribute branching through the use of a tri- or tetra-ol, although the amount of such compound should be selected to avoid gellation. It will be appreciated that the present methods for achieving branching through the use of polymerizing the unsaturation of a polycarboxylic acid and polyesters resulting therefrom are quite unique when compared with conventional branched polyesters, such as those made through the use of tri- or tetra-ols.

Any free radical initiator typically used to initiate the polymerization of unsaturated compounds containing double bonds may be used in any of the free radical polymerization reactions described above. For example, the free radical initiator can be an azo initiator or a peroxide initiator, such as tert-butyl peroxy-2-ethylhexanoate, tert-butyl peroxybenzoate or dibenzoyl peroxide. The ratio of initiator to unsaturated acid/anhydride/ester may be varied depending upon the degree of branching of the chains of the polyester that is desired. For example, the molar ratio of the initiator to the double bonds may be 0.001 to 1.0, such as 0.01 to 0.9 or 0.5 to 1. If a higher amount of initiator is used, the more branching will be achieved. A lower amount of initiator may also be used, such as 0.1, so as to minimize the amount of branching and retain some unsaturation in the polyester. This might provide particularly desirable flexibility in the final coating.

The present branched polyester resins may have a degree of branching or Mark-Houwink parameter of 0.58 or less, such as 0.50 or less or 0.48 or less as measured by triple detector GPC, alpha standard.

Depending upon the degree of control of the polymerization that is desired, the initiator can be added in different portions at different times. For example, all of the free radical initiator may be added at the start of the reaction, the initiator may be divided into portions and the portions added at intervals during the reaction, or the initiator may be added as a continuous feed. It will be appreciated that the addition of initiator at set intervals or in a continuous feed will result in a more controlled process than adding all of the initiator at the start. The initiator can be added over 10 minutes, for example, until the molecular weight of the polyester doubles or triples. The free radical polymerization can be conducted under various conditions allowing for parameters such as the molecular weight of the branched polyester resin, the degree of functionality, the amount of branching and the like to be controlled so as to obtain the branched polyester that gives the desired feel and properties to the final coating.

Regardless of the manner in which the branched polyester resin is made, such as the order in which the polyol segment, the polycarboxylic acid/anhydride/ester segment and the siloxane segment are reacted, how and when the initiator is added, and the like, the resulting branched polyester resin will actually be a mixture of polyesters with varying degrees of unsaturation, chain length, branching and the like. Some of the resulting product may even be a monoester, but is still encompassed by the term “polyester” as used herein.

The temperature at which the free radical polymerization reaction is conducted may be varied depending on factors such as the composition of the unsaturated acid/anhydride/ester segment, the siloxane compound/segment, the polyol segment monomer, the soft segment monomer, if used, the initiator, the solvent and the properties that are desired in the polyester resin and/or the final coating. Typically, the free radical polymerization is conducted at a temperature of from 50° C. to 150° C. In a typical polymerization, such as an acrylic polymerization, the higher temperature results in a higher concentration of free radicals, which in turn results in more chains being polymerized, each with a relatively low molecular weight. It has been surprisingly discovered in the present system, particularly when maleic is used, the higher the initiator concentration, the higher the molecular weight of the resulting polyester resin. This is a surprising result as those skilled in the art would not have expected the present polymerization to occur. Too much initiator, however, can lead to gellation. The polyester resin of the present invention can be, and usually is, ungelled.

While any means can be used to effect the polymerization, for ease of handling, the free radical polymerization can be performed using solutions of any of the unsaturated acid/anhydride/ester, polyol, or siloxane compound/segments, or any other components or segments used. Any solvent may be used, as long as it is able to dissolve the components including the free radical initiator to a sufficient degree to allow the polymerization to take place efficiently. Typical examples of suitable solvents include butyl glycol, propylene glycol mono methyl ether, methoxy propyl acetate and xylene. Preparation of the polyester in solvent is sometimes referred to herein as a “solvent-based system”, which means that greater than 50%, such as up to 100%, of the solvent is an organic solvent, and less than 50% of the solvent, such as less than 20%, less than 10%, less than 5%, or less than 2% of the solvent is water.

Alternatively, the polyester resin can be prepared in a water-based system. A “water-based system” is one in which greater than 50%, such as up to 100%, of the solvent is water, and less than 50% of the solvent, such as less than 20%, less than 10%, less than 5%, or less than 2% of the solvent is an organic solvent. The polymerization may also be done without solvent; that is, all steps from making the prepolymer to making the polyester resin, can be done in the absence of solvent.

In any of the solvent-based systems, the water-based system, or solvent-free system, the resulting polyester resin can be a liquid, such as a viscous liquid.

Particularly suitable prepolymers used according to the present invention may comprise adipic acid (soft segment) such as in an amount of 0 to 60 weight %, 2-methyl-1,3-propanediol (polyol segment) such as in an amount of 0 to 50 weight %, and maleic anhydride (polycarboxylic segment), such as in an amount of up to 25 weight %, such as 5 to 20 weight %. When siloxane is included in the prepolymer an acrylated siloxane (siloxane segment) such as in an amount of up to 5 weight %, such as 0.5 to 2.5 weight % or such as 1 to 2 weight %, with weight % based on total monomer weight in the prepolymer can be used. Typically, the higher the molecular weight of the siloxane segment the lower the amount can be used to impart the desired level of easy clean/stain resistance. Additional monomer can also be used, such as isophthalic acid or terephthalic acid, phthalic acid, succinic acid, and/or neopentyl glycol.

As noted above, the branched polyester resin is formed by using free radical polymerization, wherein the unsaturation of the polycarboxylic acid/anhydride/ester moieties in the prepolymers polymerize. The reaction may be run such that substantially all of the unsaturation is reacted in the formation of the branched polyester; accordingly, the cure mechanism between the polyester resin and the crosslinker may be predominantly, if not solely, through reaction of the functionality on the polyester resin with the crosslinker and not through any reaction at any points of unsaturation. That is, any reaction occurring with unsaturation that may remain in the branched polyester resin after reaction between the prepolymers is not enough to result in the coating becoming cured. Alternatively, the resulting polyester resin may comprise some degree of unsaturation. For example, the resulting polyester resin can comprise enough unsaturation to render the polyester resin reactive with other functional groups through the points of unsaturation.

Because the branching of the polyester according to the present invention is achieved through the free radical polymerization of the unsaturation in the prepolymers, the terminal hydroxyl groups will remain unreacted in the branched polyester of the present invention. These unreacted hydroxyl groups can then be crosslinked with another component. Thus, the present invention is distinct from art in which gelled polyesters, that is extensively networked polyesters, are formed. The present polyesters are thermoset, and therefore also distinct from art that teaches thermoplastic polyesters.

It may be desirable to convert some or all of the hydroxyl functionality on the unsaturated polyester prepolymer before polymerization takes place, and/or on the branched polyester, to another functionality. For example, the hydroxyl group can be reacted with a cyclic anhydride to result in acid functionality. Acid esters can also be formed.

The unsaturated polyester prepolymer may comprise linkages in addition to the ester linkages. For example, the polyester prepolymer may further comprise one or more urethane linkages. Urethane linkages could be introduced by reacting an excess of the polyol prepolymer or the unsaturated polyester polymer with a polyisocyanate. The resulting unsaturated polyester prepolymer will still have terminal functionality and unsaturation, but will have urethane linkages in addition to ester linkages. Alternatively, isocyanate functionality can be reacted to form a urethane linkage after free radical polymerization. Other chemistries could also be introduced. Accordingly, the unsaturated polyester prepolymer may comprise one or more linkages in addition to ester linkages.

It may be desired to exclude the use of unsaturated monomers other than the unsaturated polyacid/anhydride/ester used in the prepolymer, or, if such unsaturated monomers are used, to react the unsaturation during formation of the prepolymer. For example, the use of vinyl monomers such as (meth)acrylates, styrene, vinyl halides and the like in the formation of the prepolymer can be excluded. When it is desired that the only unsaturation comes from the polyacid/anhydride/ester, unsaturated monomers can still be used, for example in the siloxane segment, such as through use of a PDMS acrylate, if the double bond of the acrylate moiety is reacted in the formation of the branched polyester resin or prepolymer. Thus, the unsaturation would not be present in the branched polyester resin. Similarly, any other acrylate or methacrylate containing monomer or polymer can be used if the double bond of the acrylate moiety is reacted in the formation of the prepolymer. That is, the acrylate double bond is reacted during the formation of the prepolymer itself and therefore unavailable to react with the unsaturation of another prepolymer during free radical polymerization. It will be appreciated that the present branched polyesters are not polyester/acrylic graft copolymers, which are widely known in the art and are not formed by reaction of unsaturation on prepolymers.

Certain polyesters prepared from prepolymers that are formed by the reaction with aldehydes may be excluded from the invention; thus, acyl succinic acid polyesters may be specifically excluded. Similarly, use of aldehyde in the solvent may be specifically excluded from the scope of the invention.

The branched polyester resins of the present invention can have a relatively high molecular weight and functionality as compared to conventional linear polyester resins. Typically, the ratio of the weight average molecular weight (“Mw”) of the branched polyester resin of the present invention to the Mw of the unsaturated polyester prepolymer is from 1.2 to 100, such as 4 or 5 to 50, although it can be higher.

The polyester prepolymers can have an Mw of 1,000 to 50,000, such as 5,000 to 10,000 or 7,000 to 8,000. In addition, the final branched polyester resin can have an Mw in the range of 2,000 to 100,000, such as 4,000-10,000. The prepolymer Mw can be related to the properties of the branched polyester resin as well as a coating comprising the polyester resin reacted with a crosslinker. For example, a branched polyester resin with an Mw at the lower end of the range, such as less than 10,000, might give a higher crosslink density or hardness in the coating as there would be higher functionality, and might have better flow and lower viscosity, while a branched polyester resin with an Mw higher than 10,000 might provide a coating with a lower crosslink density or hardness, but with a different touch feel. Mw values reported here are determined as explained in the Examples.

The equivalent weight of the polyester resin may be 1000 or less. Equivalent weight is the Mw divided by the average functionality. Equivalent weight contributes to the crosslink density, which, as noted above, may affect the properties of soft touch coatings. For example, a higher equivalent weight may give a lower crosslink density.

In addition to the molecular weight described above, the branched polyester resins of the present invention can also have a relatively high functionality; in some cases the functionality is higher than would be expected for conventional polyesters having such molecular weights. The average functionality of the polyester resin can be 2.0 or greater, such as 2.5 or greater, 3.0 or greater, or even higher. “Average functionality” as used herein refers to the average number of functional groups on the branched polyester resin. The functionality of the branched polyester resin is measured by the number of hydroxyl groups that remain unreacted in the branched polyester resin, and not by the unreacted unsaturation. The hydroxyl value of the branched polyester resins of the present invention can be from 10 to 500 mg KOH/gm, such as 30 to 250 mg KOH/gm. The present branched polyester resins may have both high Mw and high functionality, such as a Mw of ≧15,000, such as 20,000 to 40,000, or higher than 40,000, and a functionality of ≧100 mg KOH/gm.

Because the polyester resin of the present invention comprises functionality, it is suitable for use in coating formulations in which the hydroxyl groups (and/or other functionality) are crosslinked with other resins and/or crosslinkers typically used in coating formulations. Thus, the present invention is further directed to a coating comprising a branched polyester resin according to the present invention and a crosslinker therefor. The crosslinker, or crosslinking resin or agent, can be any suitable crosslinker or crosslinking resin known in the art, and will be chosen to be reactive with the functional group or groups on the polyester resin. It will be appreciated that the coatings of the present invention cure through the reaction of the hydroxyl groups and/or other functionality and the crosslinker and not through the double bonds of the polycarboxylic acid/anhydride/ester moiety, to the extent any such unsaturation exists in the branched polyester resin.

Non-limiting examples of suitable crosslinkers include phenolic resins, amino resins, epoxy resins, isocyanate resins, beta-hydroxy (alkyl) amide resins, alkylated carbamate resins, polyacids, anhydrides, organometallic acid-functional materials, polyamines, polyamides, aminoplasts and mixtures thereof. The crosslinker may be for example a phenolic resin comprising an alkylated phenol/formaldehyde resin with a functionality ≧3 and difunctional o-cresol/formaldehyde resins. Such crosslinkers are commercially available from Hexion as BAKELITE 6520LB and BAKELITE 7081LB.

Suitable isocyanates include multifunctional isocyanates. Examples of multifunctional polyisocyanates include aliphatic diisocyanates like hexamethylene diisocyanate and isophorone diisocyanate, and aromatic diisocyanates like toluene diisocyanate and 4,4′-diphenylmethane diisocyanate. The polyisocyanates can be blocked or unblocked. Examples of other suitable polyisocyanates include isocyanurate trimers, allophanates, and uretdiones of diisocyanates and polycarbodiimides such as those disclosed in U.S. Pat. No. 8,389,113, incorporated by reference in pertinent part herein. Suitable polyisocyanates are well known in the art and widely available commercially. For example, suitable polyisocyanates are disclosed in U.S. Pat. No. 6,316,119 at columns 6, lines 19-36, incorporated by reference herein. Examples of commercially available polyisocyanates include DESMODUR VP2078 and DESMODUR N3390, which are sold by Bayer Corporation, and TOLONATE HDT90, which is sold by Rhodia Inc.

Suitable aminoplasts include condensates of amines and/or amides with aldehyde. For example, the condensate of melamine with formaldehyde is a suitable aminoplast. Suitable aminoplasts are well known in the art. A suitable aminoplast is disclosed, for example, in U.S. Pat. No. 6,316,119 at column 5, lines 45-55, incorporated by reference herein.

In preparing the present coatings, the branched polyester resin and the crosslinker can be dissolved or dispersed in a single solvent or a mixture of solvents. Any solvent that will enable the formulation to be coated on a substrate may be used, and these will be well known to the person skilled in the art. Typical examples include water, organic solvent(s), and/or mixtures thereof. Suitable organic solvents include glycols, glycol ether alcohols, alcohols, ketones, and aromatics, such as xylene and toluene, acetates, mineral spirits, naphthas and/or mixtures thereof. “Acetates” include the glycol ether acetates. The solvent can be a non-aqueous solvent. “Non-aqueous solvent” and like terms means that less than 50% of the solvent is water. For example, less than 10%, or even less than 5% or 2%, of the solvent can be water. It will be understood that mixtures of solvents, including or excluding water in an amount of less than 50%, can constitute a “non-aqueous solvent”. The coating may be aqueous or water-based. This means that 50% or more of the solvent is water. These embodiments have less than 50%, such as less than 20%, less than 10%, less than 5% or less than 2% solvent.

The coatings of the present invention may further comprise a curing catalyst. Any curing catalyst typically used to catalyze crosslinking reactions between polyester resins and crosslinkers, such as phenolic resins, may be used, and there are no particular limitations on the catalyst. Examples of such a curing catalyst include dibutyltin dilaurate, phosphoric acid, alkyl aryl sulphonic acid, dodecyl benzene sulphonic acid, dinonyl naphthalene sulphonic acid, phenyl acid phosphate and dinonyl naphthalene disulphonic acid.

It will be appreciated that a number of factors should be balanced to give the desired properties to the final coating. As noted above, monomer selection and content may play a role, as might Mw, equivalent weight, and degree of branching. The siloxane compound/segment contributes to the easy clean characteristic of the cured coating, as may other monomers used in the prepolymer. Anti-fingerprint properties may also be achieved through the use of the siloxane compound/segment. The Tg of the branches can be decreased so as to increase the “soft touch” quality of the coating. In addition, the selection of crosslinker can also contribute to the soft touch. For example, the crosslinker and amount of crosslinker used can be selected to give the desired crosslink density, which, as noted above, relates to touch feel.

If desired, the coating compositions can comprise other optional materials well known in the art of formulating coatings, such as colorants, plasticizers, abrasion resistant particles, anti-oxidants, hindered amine light stabilizers, UV light absorbers and stabilizers, surfactants, flow control agents, thixotropic agents, fillers, organic cosolvents, reactive diluents, catalysts, grind vehicles, slip agents and other customary auxiliaries.

As used herein, the term “colorant” means any substance that imparts color and/or other opacity and/or other visual effect, e.g. gloss, to the composition. The colorant can be added to the coating in any suitable form, such as discrete particles, dispersions, solutions and/or flakes. A single colorant or a mixture of two or more colorants can be used in the coatings of the present invention.

Example colorants include matting pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water-miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemicals, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are described, for example, in U.S. Pat. No. 7,605,194 at column 3, line 56 to column 16, line 25, the cited portion of which being incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. For example, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

A photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

The photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present invention, have minimal migration out of the coating. Example photosensitive compositions and/or photochromic compositions and methods for making them are identified in U.S. Pat. No. 8,153,344, and incorporated herein by reference.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

An “abrasion resistant particle” is one that, when used in a coating, will impart some level of abrasion resistance to the coating as compared with the same coating lacking the particles. Suitable abrasion resistant particles include organic and/or inorganic particles. Examples of suitable organic particles include but are not limited to diamond particles, such as diamond dust particles, and particles formed from carbide materials; examples of carbide particles include but are not limited to titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles. For example, the particles can be microparticles, having an average particle size of 0.1 to 50, 0.1 to 20, 1 to 12, 1 to 10, or 3 to 6 microns, or any combination within any of these ranges. The particles can be nanoparticles, having an average particle size of less than 0.1 micron, such as 0.8 to 500, 10 to 100, or 100 to 500 nanometers, or any combination within these ranges.

Any slip agent can be used according to the present invention such as those commercial available from BYK Chemie or Dow Corning.

The polyester resins of the present invention may be used as coating additives. For example, it has been discovered that the present polyesters can replace all or part of the sag control agent, such as cellulose esters, used in coating formulations comprising metallic flake. It will be appreciated that the branched polyester resins of the present invention and crosslinker therefor can form all or part of the film-forming resin of the coating. One or more additional film-forming resins can also be used in the coating. For example, the coating compositions can comprise any of a variety of thermoplastic and/or thermosetting compositions known in the art. The coating compositions may be water-based or solvent-based liquid compositions, or alternatively, may be in solid particulate form, i.e. a powder coating.

Thermosetting or curable coating compositions typically comprise film-forming polymers or resins having functional groups that are reactive with either themselves or a crosslinking agent. The additional film-forming resin can be selected from, for example, acrylic polymers, polyester polymers, polyurethane polymers, polyamide polymers, polyether polymers, polysiloxane polymers, copolymers thereof, and mixtures thereof. Generally, these polymers can be any polymers of these types made by any method known to those skilled in the art. Such polymers may be solvent-borne or water-dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof. Appropriate mixtures of film-forming resins may also be used in the preparation of the present coating compositions.

Thermosetting coating compositions typically comprise a crosslinking agent that may be selected from any of the crosslinkers described above. The present coatings can comprise a thermosetting film-forming polymer or resin and a crosslinking agent therefor and the crosslinker is either the same or different from the crosslinker that is used to crosslink the branched polyester resin. A thermosetting film-forming polymer or resin having functional groups that are reactive with themselves can also be used; in this manner, such thermosetting coatings are self-crosslinking.

The coatings of the present invention may comprise 1 to 100, such as 10 to 90 or 20 to 80 weight %, with weight % based on total solid weight of the coating, of the branched polyester resin of the present invention. The coating compositions of the present invention may also comprise 0 to 90, such as 5 to 60 or 10 to 40 weight %, with weight % based on total solids weight of the coating, of a crosslinker for the branched polyester resin. Additional components, if used, may comprise 1 weight %, up to 70 weight %, or higher, with weight % based on total solids weight of the coating.

Coating formulations according to the present invention can be easier to clean than coatings made with other polyesters, such as polyesters that do not have a siloxane group. Such “cleanability” is often expressed in terms of stain resistance. Stain resistance can be measured by the carbon stain test, described in the Examples. Coatings according to the present invention may have a Delta E of 5 or less, such as 2 or less or 1 or less as measured according to the carbon stain test.

Coating formulations according to the present invention can also have a soft touch and/or smooth feel when cured on a substrate. For example, the coating can have a softness as measured by the Fischer Micro-hardness test of 1 to 20 N/mm², such as 2 to 10 N/mm² The coating can further have a coefficient of friction as measured by ASTM Method D1894 of 0.01 to 0.5, such as 0.05 to 0.2. “Coefficient of friction” refers to the ratio of the force that maintains contact between an object and a surface and the frictional force that resists the motion of the object. The coating, at 50 micron thickness, can have an abrasion resistance as measured by ASTM Method F2357 of 50 to 500 cycles, such as 250 to 500. The cured coating can also have a surface roughness of 1 μm to 80 μm, such as 10 μm to 60 μm, 20 μm to 50 μm, or 35 μm to 45 μm as measured by a Taylor Hobson Precision Duo Profilometer. Surface roughness can be altered through formulation, such as through the use of additives, an example of which is silica. It will be appreciated by those skilled in the art that achieving this level of “cleanability”, hardness, coefficient of friction, abrasion resistance, and surface roughness in the same coating is a remarkable accomplishment. The result is a coating that is soft to the touch, but durable. While the inventors believe this combination of properties is achieved due to the branching of the polyester, they do not wish to be bound by any mechanism.

The prepolymers, the branched polyester and/or the coatings of the present invention, may be substantially free, may be essentially free and/or may be completely free of bisphenol A and epoxy compounds derived from bisphenol A (“BPA”), such as bisphenol A diglycidyl ether (“BADGE”). Such prepolymers, branched polyesters and/or coatings are sometimes referred to as “BPA non intent” because BPA, including derivatives or residues thereof, are not intentionally added but may be present in trace amounts because of impurities or unavoidable contamination from the environment. The prepolymers, branched polyesters and/or coatings can also be substantially free and may be essentially free and/or may be completely free of bisphenol F and epoxy compounds derivatived from bisphenol F, such as bisphenol F diglycidyl ether (“BFDGE”). The term “substantially free” as used in this context means the prepolymers, branched polyester resins and/or coatings contain less than 1000 parts per million (ppm), “essentially free” means less than 100 ppm and “completely free” means less than 20 parts per billion (ppb) of any of the above mentioned compounds, derivatives or residues thereof.

The present coatings can be applied to any substrates known in the art, for example, automotive substrates, industrial substrates, packaging substrates, wood flooring and furniture, apparel, electronics including housings and circuit boards and including consumer electronics such as housings for computers, notebooks, smartphones, tablets, televisions, gaming equipment, computer equipment, computer accessories, MP3 players, and the like, glass and transparencies, sports equipment including golf balls, and the like. These substrates can be, for example, metallic or non-metallic. Metallic substrates include tin, steel, tin-plated steel, chromium passivated steel, galvanized steel, aluminum, aluminum foil. Metal sheet as used herein refers to flat metal sheet and coiled metal sheet, which is coiled, uncoiled for coating and then re-coiled for shipment to a manufacturer. Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), polyamide, wood, veneer, wood composite, particle board, medium density fiberboard, cement, stone, glass, paper, cardboard, textiles, leather both synthetic and natural, and the like. The substrate can be one that has been already treated in some manner, such as to impart visual and/or color effect.

The coatings of the present invention can be applied by any means standard in the art, such as electrocoating, spraying, electrostatic spraying, dipping, rolling, brushing, and the like.

The coatings can be applied to a dry film thickness of 0.04 mils to 4 mils, such as 0.3 to 2 or 0.7 to 1.3 mils. The coatings can also be applied to a dry film thickness of 0.1 mils or greater, 0.5 mils or greater 1.0 mils or greater, 2.0 mils or greater, 5.0 mils or greater, or even thicker. The coatings of the present invention can be used alone, or in combination with one or more other coatings. For example, the coatings of the present invention can comprise a colorant or not and can be used as a primer, basecoat, and/or top coat. For substrates coated with multiple coatings, one or more of those coatings can be coatings as described herein. The present coatings can also be used as a packaging “size” coating, wash coat, spray coat, end coat, and the like.

It will be appreciated that the coatings described herein can be either one component (“1K”), or multi-component compositions such as two component (“2K”) or more. A 1K composition will be understood as referring to a composition wherein all the coating components are maintained in the same container after manufacture, during storage, etc. A 1K coating can be applied to a substrate and cured by any conventional means, such as by heating, forced air, and the like. The present coatings can also be multi-component coatings, which will be understood as coatings in which various components are maintained separately until just prior to application. As noted above, the present coatings can be thermoplastic or thermosetting.

The coating can be a clearcoat. A clearcoat will be understood as a coating that is substantially transparent or translucent. A clearcoat can therefore have some degree of color, provided it does not make the clearcoat opaque or otherwise affect, to any significant degree, the ability to see the underlying substrate. The clearcoats of the present invention can be used, for example, in conjunction with a pigmented basecoat. The clearcoat can be formulated as is known in the coatings art.

The coating may also comprise a colorant, such as a pigmented basecoat used in conjunction with a clearcoat, or as a pigmented monocoat. Such coating layers are used, for example, in the automotive industry to impart a decorative and/or protective finish to a vehicle. “Vehicle” is used herein in its broadest sense and includes all types of vehicles, such as but not limited to cars, trucks, buses, vans, golf carts, motorcycles, bicycles, railroad cars, airplanes, helicopters and the like. It will be appreciated that the portion of the vehicle that is coated according to the present invention may vary depending on why the coating is being used. For example, anti-chip primers may be applied to some of the portions of the vehicle as described above. When used as a colored basecoat or monocoat, the present coatings will typically be applied to those portions of the vehicle that are visible such as the roof, hood, doors trunk lid and the like, but may also be applied to other areas such as inside the trunk, inside the door and the like; they can also be applied to those portions of the car that are in contact with the driver and/or passengers, such as the steering wheel, dashboard, gear shift, controls, door handle and the like. Clearcoats will typically be applied to the exterior of a vehicle.

The present invention is also directed to a substrate coated at least in part with the coating of the present invention, wherein the substrate comprises a consumer electronic part. “Consumer electronic part” includes, for example, any part or housing of computers, notebooks, smartphones, tablets, televisions, gaming equipment, computer accessories, MP3 players, and the like. The coatings are typically applied to at least the exterior of the housing of such equipment, but may also be applied in whole or in part to the interior of such housing as well. The present coatings are particularly suitable for application to consumer electronics as they can provide the desired stain resistance and may also provide the desired feel and durability.

Metal coils, having wide application in many industries, are also substrates that can be coated according to the present invention; the present coatings are particularly suitable as coil coatings due to their unique combination of flexibility and hardness, as discussed above. Coil coatings also typically comprise a colorant.

The coatings of the present invention are also suitable for use as packaging coatings. The application of various pretreatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This is particularly true when the contents of the can are acidic in nature. The coatings applied to the interior of metal cans also help prevent corrosion in the headspace of the cans, which is the area between the fill line of the product and the can lid; corrosion in the headspace is particularly problematic with food products having a high salt content. Coatings can also be applied to the exterior of metal cans. Certain coatings of the present invention are particularly applicable for use with coiled metal stock, such as the coiled metal stock from which the ends of cans are made (“can end stock”), and end caps and closures are made (“cap/closure stock”). Since coatings designed for use on can end stock and cap/closure stock are typically applied prior to the piece being cut and stamped out of the coiled metal stock, they are typically flexible and extensible. For example, such stock is typically coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, typically by means of a pull tab. For caps and closures, the cap/closure stock is typically coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

Accordingly, the present invention is further directed to a package coated at least in part with any of the coating compositions described above. A “package” is anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage container or bakeware in which a consumer might make and/or store food; such a container would only maintain the freshness or integrity of the food item for a relatively short period. A package according to the present invention can be made of metal or non-metal, for example, plastic or laminate, and be in any form. An example of a suitable package is a laminate tube. Another example of a suitable package is metal can. The term “metal can” includes any type of metal can, container or any type of receptacle or portion thereof that is sealed by the food/beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating can be applied to the interior and/or the exterior of the package. For example, the coating can be rollcoated onto metal used to make a two-piece food can, a three-piece food can, can end stock and/or cap/closure stock. The coating is applied to a coil or sheet by roll coating; the coating is then cured by radiation and can ends are stamped out and fabricated into the finished product, i.e. can ends. The coating could also be applied as a rim coat to the bottom of the can; such application can be by roll coating. The rim coat functions to reduce friction for improved handling during the continued fabrication and/or processing of the can. The coating can also be applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans.

Substrates coated according to the present invention can be coated with any of the compositions described above by any means known in the art, such as spraying, rolling, dipping, brushing, flow coating and the like; the coating may also be applied by electrocoating when the substrate is conductive. The appropriate means of application can be determined by one skilled in the art based upon the type of substrate being coated and the function for which the coating is being used. The coatings described above can be applied over the substrate as a single layer or as multiple layers with multiple heating stages between the application of each layer, if desired. After application to the substrate, the coating composition may be cured by any appropriate means.

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein. Singular encompasses plural and vice versa. For example, although reference is made herein to “a” polyester, “a” branched polyester resin, “an” unsaturated acid/anhydride/ester, “a” polyol pre-polymer, “a” soft segment, “a” soft monomer, “a” polyol segment, “a” polyol segment monomer, “a” prepolymer, “a” crosslinker, “a” siloxane group, “a” siloxane segment, and the like, one or more of each of these and any other components can be used. As used herein, the term “polymer” refers to oligomers and both homopolymers and copolymers, and the prefix “poly” refers to two or more. Including, for example and like terms means including for example but not limited to. When ranges are given, any endpoints of those ranges and/or numbers within those ranges can be combined within the scope of the present invention.

Non-limiting aspects of the invention include:

1. An uncured, branched polyester resin prepared by free radical polymerization of a double bond of at least one unsaturated polyester prepolymer in the presence of an ethylenically unsaturated compound comprising a siloxane group, wherein the prepolymer comprises:
a) a polyol segment; and
b) an unsaturated polycarboxylic acid and/or an anhydride and/or ester segments.
   2. An uncured branched polyester resin prepared by free radical polymerization of the double bonds of at least one unsaturated polyester prepolymer wherein the prepolymer comprises:
a) a polyol segment;
b) an unsaturated polycarboxylic acid and/or anhydride and/or ester segment; and
c) a siloxane segment.
   3. An uncured, branched polyester resin prepared by free radical polymerization of a double bond of a first unsaturated polyester prepolymer and a double bond of a second unsaturated polyester prepolymer, wherein each prepolymer independently comprises:
a) a polyol segment; and
b) an unsaturated polycarboxylic acid and/or an anhydride and/or ester segments; and wherein at least one of the unsaturated polyester prepolymers further comprises a siloxane segment; and wherein the prepolymers are the same or different.
   4. The polyester resin of aspect 1, wherein the ethylenically unsaturated compound comprising the siloxane group comprises an acrylate functional siloxane.
   5. The polyester resin of aspect 4, wherein the acrylate functional siloxane comprises acrylated polydimethylsiloxane.
   6. The polyester resin of any of aspects 2 or 3, wherein the siloxane segment is derived from an ethylenically unsaturated compound comprising a siloxane group.
   7. The polyester resin of aspect 6, wherein the ethylenically unsaturated compound comprising the siloxane group comprises an acrylate functional siloxane.
   8. The polyester resin of aspect 7, wherein the acrylate functional siloxane comprises acrylated polydimethylsiloxane.
   9. The polyester resin of any of the preceding aspects, wherein the prepolymer comprises adipic acid, 2-methyl-1,3-propanediol, and/or maleic acid/anhydride/ester.
   10. The polyester resin of any of the preceding aspects, wherein the Mw of the prepolymer is 1,000 to 10,000 as measured by GPC against a polystyrene standard.
   11. The polyester resin any of aspects 1-10, wherein the Mw of the polyester is 4,000 to 50,000 as measured by GPC against polystyrene control.
   12. The polyester resin of any of the preceding aspects, wherein the Mark Houwink parameter of the polyester resin is 0.48 or less, wherein the Mark Houwink parameter, alpha value, is measured by GPC-Triple detection.
   13. The polyester resin of any of the preceding aspects, wherein the polyester does not comprise unsaturated moieties from (meth)acrylate compounds.
   14. The polyester resin of any of the preceding aspects, wherein the only unsaturation in the prepolymers is from component b).
   15. A coating composition comprising the polyester resin any of aspects 1-14 and a crosslinker therefor, wherein the crosslinker comprises functional groups reactive with function groups on the polyester resin.
   16. The coating composition of aspect 15, which, when cured, has a Delta E value of less than 1 when measured according to the carbon stain test.
   17. The coating composition of any of aspects 15 or 16, wherein the coating further comprises a colorant.
   18. The coating composition of any of aspects 15-17, wherein the crosslinker comprises isocyanate.
   19. A substrate coated at least in part with the coating composition of any of aspects 15-18.
   20. The substrate of claim 19, wherein the substrate is selected from a substrate comprising
a consumer electronic part; or
PC/ABS; or
a metal coil; or
metal sheet; or
a metal can.

### EXAMPLES

The following examples are intended to illustrate the invention and should not be construed as limiting the invention in any way.

The hydroxyl number (OH number) was determined by esterification of the sample with excess acetic anhydride at elevated temperatures using imidazole as a catalyst. The excess acetic anhydride was converted to acetic acid by hydrolysis and titrated potentiometrically with methanolic potassium hydroxide. The volume difference, in milliliters, between a blank determination (no reaction) and the sample determination correspond to the hydroxyl content of the sample.

The acid value was a measure of the free acidity in the nonvolatile portion of solvent and water-based materials. The sample was dissolved in an appropriate solvent and titrated potentiometrically with methanolic potassium hydroxide. The acid number of the sample was equal to the number of milligrams of potassium hydroxide required to neutralize the acid in one gram of the test material as measured by potentiometric titration.

Hardness was measured with the HM2000S Fischer Microhardness Instrument following the instruction described in the Fischerscope HM2000 Manual. Three measurements were conducted and the average hardness value was recorded and reported.

Surface roughness was measured by a Taylor Hobson Precision Surtronic Duo Profilometer, following the instructions provided by the manufacturer. Three tests were run on each sample and averaged.

Abrasion resistance was measured according to ASTM Method F2357.

Methyl ethyl ketone double rubs was tested by National Coil Coalers Association Technical Bulletin No. II-18 (May, 1980).

Pencil Hardness was tested according to ASTM D3363-05.

Flexibility was tested by the T-bend test according to ASTM D 4145-10.

QUV testing was conducted according to ASTM G 154-06.

Gloss was measured by ASTM D 523-14 before and after QUV testing and the percentage gloss retained was calculated.

RCA performance was evaluated with A Norman Tool RCA tester following ASTM F2357. A test load of 175 grams and test speed of 17 cycles/min were used with Norman 11/16″ wide paper roll.

Coefficient of Friction (COF) testing was conducted using a Dynisco 1055 Coefficient of Friction Tester, a Chatillion DGGS Force Gauge and a green felt plate. Test conditions: Surface=sample to green felt, 206.7 grams weight, speed=6 in/min, 72° F./28% RH. Three tests were run on each sample. The coefficient of friction was calculated from the average force required after the initial 2 seconds of the test.

The cross-hatch adhesion test was conducted following ASTM D3359 using 12 cuts (1 mm*1 mm, each 20 mm long) and 3M Scotch tape 8898.

Tg was measured according to ASTM D3418-15 Standard Test Method for Transition Temperatures and Enthalpies of Fusion and Crystallization of Polymers by Differential Scanning calorimetry.

Weight average molecular weight (Mw) was measured using gel permeation chromatography (GPC). GPC was performed using a Waters 410 differential refractometer (RI detector). Tetrahydofuran (THF) was used as the eluent at a flow rate of 1 ml min⁻¹, and two PL Gel Mixed C columns were used for separation. Mw of samples was measured relative to linear polystyrene standards of 800 to 900,000.

Mark-Houwink parameter was determined using GPC-Triple detection, alpha standard. GPC-Triple detection was performed using a Waters 2695 separation module with a Wyatt Technology Light Scattering detector (miniDAWN)/a differential refractive index detector (Optilab rEX)) and a Differential Viscometer detector (Viscostar). Tetrahydrofuran (THF) was used as the eluent at a flow rate of 1 ml min⁻¹, and three PL Gel Mixed C columns were used. Samples were vacuum dried (without heating) prior to analysis. Absolute Molecular Weight can be measured without a need of calibration standards. The performance of instrument was validated by a polystyrene standard of 30,000. Polymer branching was quantified using the Mark-Houwink parameter, alpha standard.

Fingerprint resistance was evaluated by pressing an actual fingerprint on a coated panel and visually comparing the degree of fingerprint transfer relative to a control panel. A lower number indicates better fingerprint resistance.

Easy clean performance was evaluated by pressing an actual fingerprint on a coated panel and wiping the fingerprint with KLEENEX tissue paper. A lower number indicates better easy clean performance.

Touch feel was evaluated by measuring the Fisher microhardness, surface roughness, and coefficient of friction of a coated panel.

Fisher microhardness (FMH) test was conducted with a Fisher Microhardness tester according to manufacturer's instructions. Three tests were run on each sample and averaged.

The surface roughness (Ra) was measured with a Surtronic 3 Profilometer according to manufacturer's instructions. Three tests were run on each sample and averaged.

Stain Resistance for Example 8: Stain chemicals (sunscreen, ketchup, mustard, lipstick, Vaseline) were applied to the surface of test panels evenly and slightly. Panels were cleaned with Wypall L30 paper and inspected for the trace of chemical stain.

### Example 1

An unsaturated polyester prepolymer was prepared as follows. A total of 4050 grams of 2,2-dimethyl-1,3-propanediol, 953 grams of adipic acid, 1548 grams of isophthalic acid, 966 grams of phthalic anhydride, 1205 grams of maleic anhydride, 4.4 grams of triphenyl phosphite and 8.7 grams of butylstannoic acid were added to a 12-liter, 4-neck round bottom flask equipped with a stirrer, a steam-cooled column topped with a distillation head and a thermocouple. The contents were heated slowly under a flow of nitrogen gas. The contents of the flask were heated to about 135° C. at which time they were melted and stirring was started. The batch was heated to 160° C. at which time water began distilling. Heating was continued to a batch temperature of 220° C. A total of 904 grams of water was removed from the reaction. The final acid value of the resin was measured as 7. The contents of the batch were cooled to 150° C. and poured out. The solids content was 99.9% by weight. The OH number of the resin was found to be 60 at 100% solids. The weight average molecular weight of the product was found to be 4941.

A branched polyester resin according to the present invention was prepared as follows. A total of 490 grams of the above prepolymer resin was placed in a 3-liter, 4-neck round bottom flask equipped with a stirrer, a water-cooled condenser, an addition funnel and a thermocouple. A total of 159 grams of Aromatic 100 and 40 grams of Dowanol PM Acetate were added. The contents of the flask were heated to 80° C. and 10 grams of Silmer ACR Mo8 (acrylate functional siloxane from Siltech) was added. The contents of the flask were then heated to 120° C. with stirring. A total of 1.3 grams of a 50% solution of tert-butyl peroctoate and 13 grams of Dowanol PM Acetate were mixed and placed into the addition funnel. The contents of the funnel were added to the flask over 10 minutes. The temperature of the reaction was maintained at 120° C. for one hour. It was then cooled and the contents poured out. The final resin had a solids content of 70% by weight. The OH number of the resin was found to be 40 at 70% solids. The polymer had a weight average molecular weight of 7188.

### Example 2

An unsaturated polyester prepolymer was prepared as follows.

A total of 4050 grams of 2,2-dimethyl-1,3-propanediol, 953 grams of adipic acid, 1548 grams of isophthalic acid, 966 grams of phthalic anhydride, 1205 grams of maleic anhydride, 4.4 grams of triphenyl phosphite and 8.7 grams of butylstannoic acid were added to a 12-liter, 4-neck round bottom flask equipped with a stirrer, a steam-cooled column topped with a distillation head and a thermocouple. The contents were heated slowly under a flow of nitrogen gas. The contents of the flask were heated to about 135° C. at which time they were melted and stirring was started. The batch was heated to 160° C. at which time water began distilling. Heating was continued to a batch temperature of 220° C. A total of 904 grams of water was removed from the reaction. The final acid value of the resin was measured as 7. The contents of the batch were cooled to 150° C. and poured out. The solids content was 99.9% by weight. The OH number of the resin was found to be 60 at 100% solids. The weight average molecular weight of the product was found to be 4941.

A branched polyester resin according to the present invention was prepared as follows. A total of 480 grams of the above prepolymer resin was placed in a 3-liter, 4-neck round bottom flask equipped with a stirrer, a water-cooled condenser, an addition funnel and a thermocouple. A total of 160 grams of Aromatic 100 and 40 grams of Dowanol PM Acetate were added. The contents of the flask were heated to 80° C. and 20 grams of Silmer ACR Mob was added. The contents of the flask were then heated to 120° C. with stirring. A total of 1.3 grams of a 50% solution of tert-butyl peroctoate and 13 grams of Dowanol PM Acetate were mixed and placed into the addition funnel. The contents of the funnel were added to the flask over 10 minutes. The temperature of the reaction was maintained at 120° C. for one hour. It was then cooled and the contents poured out. The final resin had a solids content of 69% by weight. The OH number of the resin was found to be 40 at 69% solids. The polymer had a weight average molecular weight of 7364.

### Example 3

A comparative polyester was prepared as follows. A total of 750 grams of 2,2-dimethyl-1,3-propanediol, 176 grams of adipic acid, 286 grams of isophthalic acid, 179 grams of phthalic anhydride, 223 grams of maleic anhydride, 0.8 grams of triphenyl phosphite and 1.6 grams of butylstannoic acid were added to a 3-liter, 4-neck round bottom flask equipped with a stirrer, a steam-cooled column topped with a distillation head and a thermocouple. The contents were heated slowly under a flow of nitrogen gas. The contents of the flask were heated to about 140° C. at which time they were melted and stirring was started. The batch was heated to 162° C. at which time water began distilling. Heating was continued to a batch temperature of 222° C. A total of 166 grams of water was removed from the reaction. The final acid value of the resin was measured as 6. The contents of the batch were cooled to 150° C. and 325 grams of Aromatic 100 was added. The resin was then poured out. The solids content was 81.8% by weight. The OH number of the resin was found to be 40 at 81.8% solids. The weight average molecular weight of the product was found to be 6798.

A total of 737 grams of the above resin was placed in a 2-liter, 4-neck round bottom flask equipped with a stirrer, a water-cooled condenser, an addition funnel and a thermocouple. A total of 5 grams of Aromatic 100 was added to the contents. The contents of the flask were then heated to 120° C. with stirring. A total of 1.6 grams of a 50% solution of tert-butyl peroctoate and 9 grams of Aromatic 100 were mixed and placed into the addition funnel. The contents of the funnel were added to the flask over 10 minutes. The temperature of the reaction was maintained at 120° C. for one hour. It was then cooled, 47 grams of Dowanol PM Acetate was added and the contents of the flask poured out. The final resin had a solids content of 74% by weight. The OH number of the resin was found to be 38 at 74% solids. The polymer had a weight average molecular weight of 7071.

### Example 4

Coatings were prepared by Cowles dispersion to a fineness of 7.5 on Hegman grind gauge using the amounts shown below:

| | Comparative | | |
|---|---|---|---|
| Raw Material | Example 3 | Example 1 | Example 2 |
| Polyester of Example 3 | 48.8 | — | — |
| Polyester Resin of | — | 48.6 | — |
| Example 1 | | | |
| (2% Silmer ACR Mo8 | | | |
| content) | | | |
| Polyester Resin of | — | — | 48.7 |
| Example 2 (4% Silmer | | | |
| ACR Mo8 content) | | | |
| Cymel 303 LF (highly | 4.8 | 4.8 | 4.8 |
| methylated, monomeric | | | |
| melamine crosslinker | | | |
| Allnex) | | | |
| Epikote 880 (bisphenol | 0.8 | 0.8 | 0.8 |
| A/epichlorohydrin type | | | |
| epoxy polymer from | | | |
| Momentive) | | | |
| Tiona 595 Titanium | 32.2 | 32.3 | 32.2 |
| Dioxide (Cristal) | | | |
| Versaflow | 0.2 | 0.2 | 0.2 |
| (Polyethylene wax from | | | |
| Shamrock) | | | |
| Coatasil 7500 (Silicon- | 0.2 | 0.2 | 0.2 |
| polyether block | | | |
| copolymer from | | | |
| Momentive) | | | |
| Dynoadd F-1 | 0.3 | 0.3 | 0.3 |
| (Polymeric, non- | | | |
| silicone flow and anti- | | | |
| crater additive from | | | |
| Dyneon) | | | |
| Cycat 4040 (catalyst | 0.3 | 0.3 | 0.3 |
| from Allnex) | | | |
| n-Butanol (BASF) | 1.2 | 1.2 | 1.2 |
| Solvesso 100 (Exxon) | 5.6 | 5.6 | 5.6 |
| 2-BUTOXYETHANOL | 5.6 | 5.6 | 5.6 |
| (Dow) | | | |
| Total | 100 | 100 | 100 |

The coatings were tested by applying each coating with a wire-wrapped draw bar according to ASTM D 4147-99 on a Bonderite 1402W pretreated aluminum panel and curing the coating to produce a cured thickness of 0.7-0.8 mil at a cure schedule of 30 seconds at a 450° F. peak metal temperature and using the test methods indicated above. To assess the outdoor stain resistance of the coatings, a carbon black stain test was conducted using the following procedure:

1. Mix or shake the carbon black slurry and wait until the foam has dissipated.

Carbon black slurry formula

| | |
|---|---|
| Deionized Water | 400 grams |
| Lamp Black LB-1011 (Harcros) | 40 grams |
| Triton X-100 (Union Carbide) | 4 grams |

Mix 15 minutes on high speed.

2. Dip part of the test panel in the carbon black slurry for about 5 seconds.
3. Place the panel coating side up on a towel and dry for 1 hour in the 120° F. electric oven.
4. Remove panel from the oven and let panel cool down to ambient temperature.
5. Wash the panel.
a) Wash panel with warm water and wipe off excess stain with a Scott Precision Wipe.
b) Pour 1% Tide solution on the panel and clean stain by wiping panel firmly with a Scott Precision Wipe. Wash panel until no more stain can be removed with towel.
c) Finally, rinse panel with warm water and dry panel.

Panel is rated by a Delta E measurement on the stained portion of the panel versus an unstained portion of the panel using a MacBeth Color-eye 2125 or equivalent using the Hunter Lab color space and D65 illuminant. Delta E numbers with less than 1.0 exhibit minimal or no staining. This test and rating system are referred to herein as the “carbon stain test”.

Results are as follows:

| | Comparative | | |
|---|---|---|---|
| Tests | Example 3 | Example 1 | Example 2 |
| 60° Gloss | 93 | 92 | 91 |
| MEK Double | >100 | >100 | >100 |
| Rubs | | | |
| Pencil Hardness | 2H | 2H | 2H |
| T-bend (No | 0T | 0T | 0T |
| adhesion loss) | | | |
| Carbon Stain Test | 43.2 | 0.45 | 0.52 |
| Gloss Retention | 87 | 99 | 96 |
| after 1000 hours | | | |
| QUV-A | | | |

As shown in the above table, the stain resistance of the two coatings prepared according to the present invention (Examples 1 and 2, having a polyester resin with 2 and 4 weight % siloxane content) had markedly improved stain resistance as compared to the comparative example in which there were no siloxane groups. Gloss retention was also higher, while all of the other properties were about the same.

### Example 5

A comparative polyester was made as follows. A total of 650 grams of 2-methyl-1,3-propanediol, 605 grams of adipic acid, 223 grams of maleic anhydride and 1.5 grams of butylstannoic acid were added to a 3-liter, 4-neck round bottom flask equipped with a stirrer, a steam-cooled column topped with a distillation head and a thermocouple. The contents were heated slowly under a flow of nitrogen gas. At about 114° C., the contents of the flask had melted and stirring was started. The batch was heated to 156° C. at which time water began distilling Heating was continued to a batch temperature of 220° C. A total of 182 grams of water was removed from the reaction. The acid value of the resin was measured as 2.9. The contents of the batch were cooled to 160° C. and 303 grams of Aromatic 100 was added. The material in the flask was then cooled and poured out. The solids content was 82% by weight. The OH number of the resin was found to be 54 at 82% solids. The weight average molecular weight of the product was found to be 6000.

A total of 979 grams of the above resin was placed in a 3-liter, 4-neck round bottom flask equipped with a stirrer, a water-cooled condenser, an addition funnel and a thermocouple. The contents of the flask were heated to 120° C. while stirring under a nitrogen gas blanket. A total of 2 grams of a 50% solution of tert-butyl peroctoate in odorless mineral spirits and 162 grams of butyl acetate were mixed and placed into the addition funnel. The contents of the funnel were added to the flask over 10 minutes. The temperature of the reaction was maintained at 120° C. for one hour. It was then cooled and the contents poured out. The final resin had a solids content of 71% by weight. The OH number of the resin was found to be 51 at 71% solids. It had a weight average molecular weight of 7400.

### Example 6

An unsaturated polyester prepolymer was prepared as follows. A total of 3450 grams of 2-methyl-1,3-propanediol, 3024 grams of adipic acid, 1116 grams of maleic anhydride and 7.4 grams of butylstannoic acid were added to a 12-liter, 4-neck round bottom flask equipped with a stirrer, a steam-cooled column topped with a distillation head and a thermocouple. The contents were heated slowly under a flow of nitrogen gas. At about 119° C. the contents of the flask had melted and stirring was started. The batch was heated to 138° C. at which time water began distilling Heating was continued to a batch temperature of 220° C. A total of 935 grams of water was removed from the reaction. The final acid value of the resin was measured as 4.7. The contents of the batch were cooled to 153° C. and 1512 grams of Aromatic 100 was added. The material in the flask was then cooled and poured out. The solids content was 81% by weight. The OH number of the resin was found to be 60 at 81% solids. The weight average molecular weight of the product was found to be 5040.

A branched polyester resin according to the present invention was prepared as follows. A total of 608 grams of the above prepolymer resin along with 82 grams of butyl acetate were placed in a 3-liter, 4-neck round bottom flask equipped with a stirrer, a water-cooled condenser, an addition funnel and a thermocouple. A total of 10 grams of Silmer ACR Mob were then added and the contents of the flask were heated to 120° C. while stirring under a nitrogen gas blanket. A total of 1.3 grams of a 50% solution of tert-butyl peroctoate in odorless mineral spirits and 13 grams of butyl acetate were mixed and placed into the addition funnel. The contents of the funnel were added to the flask over 10 minutes. The temperature of the reaction was maintained at 120° C. for one hour. It was then cooled and the contents poured out. The final resin had a solids content of 70% by weight. The OH number of the resin was found to be 51 at 70% solids. It had a weight average molecular weight of 5970.

### Example 7

An unsaturated polyester prepolymer was prepared as follows. A total of 3450 grams of 2-methyl-1,3-propanediol, 3024 grams of adipic acid, 1116 grams of maleic anhydride and 7.4 grams of butylstannoic acid were added to a 12-liter, 4-neck round bottom flask equipped with a stirrer, a steam-cooled column topped with a distillation head and a thermocouple. The contents were heated slowly under a flow of nitrogen gas. At about 119° C. the contents of the flask had melted and stirring was started. The batch was heated to 138° C. at which time water began distilling Heating was continued to a batch temperature of 220° C. A total of 935 grams of water was removed from the reaction. The final acid value of the resin was measured as 4.7. The contents of the batch were cooled to 153° C. and 1512 grams of Aromatic 100 was added. The material in the flask was then cooled and poured out. The solids content was 81% by weight. The OH number of the resin was found to be 60 at 81% solids. The weight average molecular weight of the product was found to be 5040.

A branched polyester resin according to the present invention was prepared as follows. A total of 608 grams of the above prepolymer resin, 82 grams of butyl acetate and 10 grams of Shin Etsu X22-2426 (methacryl-modified silicone fluids) were placed in a 3-liter, 4-neck round bottom flask equipped with a stirrer, a water-cooled condenser, an addition funnel and a thermocouple. The contents of the flask were heated to 120° C. while stirring under a nitrogen gas blanket. A total of 1.3 grams of a 50% solution of tert-butyl peroctoate in odorless mineral spirits and 13 grams of butyl acetate were mixed and placed into the addition funnel. The contents of the funnel were added to the flask over 10 minutes. The temperature of the reaction was maintained at 120° C. for one hour. It was then cooled and the contents poured out. The final resin had a solids content of 71% by weight. The OH number of the resin was found to be 52 at 71% solids. It had a weight average molecular weight of 6212.

### Example 8

Coatings were made using the amounts shown in the below table. More specifically 59.49 grams of polyester, 17 grams of ethyl acetate, 5 grams of diacetone alcohol, 5 grams of PM acetate, and 0.4 grams of DISPERBYK-103 (wetting and dispersing additive for solvent-borne matting agent pastes; solution of a copolymer with filler affinic groups) were added to a half pint metal can equipped with an overhead mechanical stirrer. The above mixture was gently mixed for 5-10 minutes, and 6.5 grams of ACEMATT TS-100 (untreated thermal silica with high matting efficiency and high transparency) silica was subsequently added. The mixture was continued to mix under high speed for 20-30 minutes. A total of 1 gram of SILOK-3200 (organic-modified polydimethylsiloxane), 0.6 grams of BLS 292 (liquid hindered amine light stabilizer) and 0.1 grams of dibutyltin dilaurate were finally added to the metal can and mixed for another 5 minutes. The resulting mixture was mixed with 26 grams of XPH80002 (solution of hexamethylene diisocyanate trimer) hardener and reduced with GXS73037 (organic solvent mixture) reducer to an appropriate spray viscosity. The resulting coatings were sprayed on a polycarbonate substrate and cured at 60° C. for 30 mins with a dry film build around 55 microns. The final coating on polycarbonate substrate showed hardness of 3.0 N/mm2, a coefficient of friction of 0.07, a surface roughness of 38, and an abrasion resistance of 350 cycles when measured after initial cure and 600 cycles after 5 days. The coating was tested for stain resistance against common household products and exhibited stain resistance to ketchup, sunscreen, petroleum jelly and hand lotion, while slight staining occurred with mustard and lipstick.

| | Comparative | | |
|---|---|---|---|
| Raw Material | Example 5 | Example 6 | Example 7 |
| Polyester Comparative | 59.49 | — | — |
| from Example 5 | | | |
| Polyester | — | 59.49 | — |
| 2% Silmer from | | | |
| Example 6 | | | |
| Polyester | — | — | 59.49 |
| 2% Shinetsu from | | | |
| Example 7 | | | |
| PM Acetate (BASF) | 5 | 5 | 5 |
| Diacetone alcohol | 5 | 5 | 5 |
| (Arkema) | | | |
| Dispersbyk 103 (BYK | 0.40 | 0.40 | 0.40 |
| Chemie) | | | |
| Ethyl acetate (Eastman) | 21.1 | 21.1 | 21.1 |
| Byk-410 (Solution of a | 0.2 | 0.2 | 0.2 |
| modified urea from | | | |
| BYK Chemie) | | | |
| TS-100 silica (Evonik) | 5.5 | 5.5 | 5.5 |
| Amorso-684 (Solution | 0.7 | 0.7 | 0.7 |
| of a fluoro-containing | | | |
| non-ionic surfactant | | | |
| from Amorso Inc) | | | |
| Silok 3200 (Guangzhua | 1.0 | 1.0 | 1.0 |
| Silok Polymer) | | | |
| 10% DBDTL soln (Air | 1.8 | 1.8 | 1.8 |
| Products) | | | |
| Acetyl acetone | 2.0 | 2.0 | 2.0 |
| (Eastman) | | | |
| Total | 102.19 | 102.19 | 102.19 |

Results are as follows:

| | Comparative | | |
|---|---|---|---|
| Tests | Example 5 | Example 6 | Example 7 |
| Fingerprint | 4 | 2 | 2 |
| resistance | | | |
| Easy Clean | 6 | 2 | 2 |
| Touch Feel | 4 | 4 | 4 |
| RCA Abrasion | 500 | 500 | 380 |
| FMH (N/mm²) | 3 | 2.3 | 2.4 |
| Coefficient of | 0.13 | 0.12 | 0.07 |
| Friction | | | |
| Ra (min) | 32 | 33 | 38 |
| Adhesion | 4B | 1B | 4B |
| Pencil | F | F | F |
| Hardness | | | |
| Stain resistance | Mustard, | Mustard, | Mustard, |
| | Lipstick, | Lipstick, | Lipstick, |
| | Sunscreen: stain; | Sunscreen: stain; | Sunscreen: stain; |
| | Ketchup, | Ketchup, | Ketchup, |
| | Vaseline: pass | Vaseline: pass | Vaseline: pass |

As shown in the above table, the coatings according to the present invention have improved easy clean and anti-fingerprint properties than the control while having the same touch feel.

What is claimed is:

1. An uncured, branched polyester resin prepared by free radical polymerization of a double bond of at least one unsaturated polyester prepolymer in the presence of an ethylenically unsaturated compound comprising a siloxane group, wherein the prepolymer comprises:
c) a polyol segment; and
d) an unsaturated polycarboxylic acid and/or an anhydride and/or ester segments.

2. The polyester resin of claim 1, wherein the ethylenically unsaturated compound comprising the siloxane group comprises an acrylate functional siloxane.

3. The polyester resin of claim 2, wherein the acrylate functional siloxane comprises acrylated polydimethylsiloxane.

4. The polyester resin of claim 2, wherein the prepolymer comprises adipic acid, 2-methyl-1,3-propanediol, and/or maleic acid/anhydride/ester.

5. The polyester resin of claim 1, wherein the Mw of the prepolymer is 1,000 to 10,000 as measured by GPC against a polystyrene standard.

6. The polyester resin of claim 1, wherein the Mw of the polyester is 4,000 to 50,000 as measured by GPC against polystyrene control.

7. The polyester resin of claim 1, wherein the Mark Houwink parameter of the polyester resin is 0.48 or less, wherein the Mark Houwink parameter, alpha value, is measured by GPC-Triple detection.

8. A coating composition comprising the polyester resin of claim 1 and a crosslinker therefor, wherein the crosslinker comprises functional groups reactive with function groups on the polyester resin.

9. The coating composition of claim 8, which, when cured, has a Delta E value of less than 1 when measured according to the carbon stain test.

10. The coating composition of claim 8, wherein the prepolymer comprises adipic acid, 2-methyl-1,3-propanediol, and/or maleic acid/anhydride/ester.

11. The coating composition of claim 8, wherein the coating further comprises a colorant.

12. The coating composition of claim 8, wherein the crosslinker comprises isocyanate.

13. A substrate coated at least in part with the coating composition of claim 8.

14. The substrate of claim 13, wherein the substrate comprises a consumer electronic part.

15. The substrate of claim 13, wherein the substrate comprises PC/ABS.

16. The substrate of claim 13, wherein the substrate comprises a metal coil.

17. The substrate of claim 13, wherein the substrate comprises metal sheet.

18. The substrate of claim 13, wherein the substrate comprises a metal can.

19. The polyester resin of claim 1, wherein the polyester does not comprise unsaturated moieties from (meth)acrylate compounds.

20. The polyester resin of claim 1, wherein the only unsaturation in the prepolymers is from component b).

21. An uncured branched polyester resin prepared by free radical polymerization of the double bonds of at least one unsaturated polyester prepolymer wherein the prepolymer comprises:
a) a polyol segment;
b) an unsaturated polycarboxylic acid and/or anhydride and/or ester segment; and
c) a siloxane segment.

22. An uncured, branched polyester resin prepared by free radical polymerization of a double bond of a first unsaturated polyester prepolymer and a double bond of a second unsaturated polyester prepolymer, wherein each prepolymer independently comprises:
a) a polyol segment; and
b) an unsaturated polycarboxylic acid and/or an anhydride and/or ester segments; and wherein at least one of the unsaturated polyester prepolymers further comprises a siloxane segment; and wherein the prepolymers are the same or different.
